(19) United States
(12) Patent Application Publication
(10) Pub. No.: US 2025/0286639 A1
(43) Pub. Date: Sep. 11, 2025

(54) RADIO DEVICE, RADIO DEVICE CONTROL METHOD, AND NON-TRANSITORY COMPUTER READABLE MEDIUM FOR PROGRAM

(71) Applicant: Panasonic Automotive Systems Co., Ltd., Kanagawa (JP)

(72) Inventors: Masataka YAMAMOTO, Kanagawa (JP); Tomoyasu FUJISHIMA, Kanagawa (JP); Masaki KUNIMATSU, Tokyo (JP); Kohei KAWANO, Kanagawa (JP)

(21) Appl. No.: 19/068,784

(22) Filed: Mar. 3, 2025

(30) Foreign Application Priority Data
Mar. 8, 2024 (JP) 2024-036245

(51) Int. Cl. H04H 20/10; G10L 21/04; H04H 20/22; H04H 20/72; H04H 40/27; H04H 60/12; H04L 12/18; H04W 4/06

(52) U.S. Cl. CPC H04H 20/106; G10L 21/04; H04H 20/22; H04H 20/72; H04H 40/27; H04H 60/12; H04L 12/189; H04W 4/06

(57) ABSTRACT

There is provided a radio device including: a reception unit that receives a radio signal of radio broadcasting; another reception unit that receives a radio signal of IP simulcast radio broadcasting; a calculation unit that calculates a time difference between a broadcast radio audio based on the radio signal received by the reception unit and an IP radio audio based on the radio signal received by another reception unit; a prediction unit that predicts a grace time until switching from the broadcast radio audio to the IP radio audio based on the time difference; another calculation unit that calculates a stretch rate based on the grace time; and a switching unit that stretches the broadcast radio audio using the stretch rate to output an audio until the grace time elapses, and switches to an audio output of the IP radio audio when the grace time elapses.

### CROSS-REFERENCE TO RELATED APPLICATIONS

This application is based on and claims priority under 35 USC 119 from Japanese Patent Application No. 2024-036245 filed on Mar. 8, 2024, the contents of which are incorporated herein by reference.

### TECHNICAL FIELD

The present disclosure relates to a radio device, a radio device control method, a program, and a non-transitory computer readable medium for the program.

### BACKGROUND ART

In the related art, in a radio device mounted on a vehicle or the like, a reception environment of a signal changes with movement of the vehicle on which the radio device is mounted, and thus there is a demand for audio output control that takes such an environmental change into account.

In addition, in the radio device, broadcasting of the same content is received by a different method or the like, and the same content is switched and output. For example, JP2013-201469A discloses a configuration in which an audio signal of a broadcast wave type broadcast and an audio signal of an IP type simulcast broadcast are switched. In JP2013-201469A, a playback speed of the broadcast wave type broadcast is stretched in consideration of the deviation of an audio between the broadcast wave type broadcast and the IP type simulcast broadcast, thereby reducing discomfort of a user at the time of switching.

In a case where a stretch rate of the playback speed of the audio before the switching is increased as in JP2013-201469A, the user may feel uncomfortable about the content of the audio in proportion thereto. On the other hand, when the stretch rate is set to be small, a time required for a switching timing to match each other between the two broadcastings becomes long. For example, a reception condition of the in-vehicle radio device changes every moment as the vehicle moves. At this time, when the reception condition of the radio broadcasting before the switching further deteriorates and the radio broadcasting cannot be played, the radio broadcasting is switched to the IP radio broadcasting at that time point. That is, because of waiting for a switching timing, a deviation between the audios before and after the switching appears, and as a result, the user may feel uncomfortable.

With respect to the two problems contrary to each other as described above, in JP2013-201469A, the stretch rate is set within a range in which the user does not feel uncomfortable. However, it is difficult to achieve both the minimization of the stretch rate for the output of the audio before the switching and the minimization of a time required for matching the switching timing.

### SUMMARY OF INVENTION

The present disclosure provides a radio device mounted on a vehicle or the like, a control method thereof, a program, and a non-transitory computer readable medium for the program, which can reduce discomfort of a user at the time of switching a broadcast.

According to an illustrative aspect of the present disclosure, a radio device includes: a first reception unit configured to receive a radio signal of radio broadcasting; a second reception unit configured to receive a radio signal of IP simulcast radio broadcasting; a time difference calculation unit configured to calculate a time difference between a broadcast radio audio based on the radio signal received by the first reception unit and an IP radio audio based on the radio signal received by the second reception unit; a prediction unit configured to predict a grace time until switching from the broadcast radio audio to the IP radio audio based on the time difference; a stretch rate calculation unit configured to calculate a stretch rate based on the grace time; and a switching unit configured to stretch the broadcast radio audio using the stretch rate to output an audio until the grace time elapses, and switch to an audio output of the IP radio audio when the grace time elapses.

According to another illustrative aspect of the present disclosure, a radio device control method includes: a first reception operation of receiving a radio signal of radio broadcasting; a second reception operation of receiving a radio signal of IP simulcast radio broadcasting; a calculation operation of calculating a time difference between a broadcast radio audio based on the radio signal received by the first reception operation and an IP radio audio based on the radio signal received by the second reception operation; a prediction operation of predicting a grace time until switching from the broadcast radio audio to the IP radio audio based on the time difference; a calculation operation of calculating a stretch rate based on the grace time; and a switching operation of stretching the broadcast radio audio using the stretch rate to output an audio until the grace time elapses, and switching to an audio output of the IP radio audio when the grace time elapses.

According to another illustrative aspect of the present disclosure, there are provided a program for causing a computer to execute a control process, and a non-transitory computer readable medium storing the program. The control process includes: a first reception operation of receiving a radio signal of radio broadcasting; a second reception operation of receiving a radio signal of IP simulcast radio broadcasting; a calculation operation of calculating a time difference between a broadcast radio audio based on the radio signal received by the first reception operation and an IP radio audio based on the radio signal received by the second reception operation; a prediction operation of predicting a grace time until switching from the broadcast radio audio to the IP radio audio based on the time difference; a calculation operation of calculating a stretch rate based on the grace time; and a switching unit of stretching the broadcast radio audio using the stretch rate to output an audio until the grace time elapses, and switching to an audio output of the IP radio audio when the grace time elapses.

Any combination of the above components, and conversion of an expression of the present disclosure between a method, a device, a system, a storage medium, a computer program, and the like are also effective in an aspect of the present disclosure.

According to the present disclosure, it is possible to reduce discomfort of a user at the time of switching a broadcast in a radio device mounted on a vehicle or the like.

### BRIEF DESCRIPTION OF DRAWINGS

FIG. 1 is a block diagram illustrating a configuration example of a radio device according to Embodiment 1;

FIG. 2 is a flowchart of a switching process according to Embodiment 1;

FIG. 3 is a flowchart of a grace time prediction process according to Embodiment 1;

FIG. 4 is a conceptual diagram illustrating a grace time according to the present disclosure;

FIG. 5 is a graph illustrating a prediction method of a grace time according to Embodiment 1;

FIG. 6 is a conceptual diagram illustrating stretching of a signal according to the present disclosure;

FIG. 7 is a flowchart of a grace time prediction process according to a modification of Embodiment 1;

FIG. 8 is a block diagram illustrating a configuration example of a radio device according to Embodiment 2;

FIG. 9 is a flowchart of a grace time prediction process according to Embodiment 2; and

FIG. 10 is a graph illustrating a distance characteristic of reception power according to the present disclosure.

### DESCRIPTION OF EMBODIMENTS

Hereinafter, embodiments that specifically disclose a radio device, a radio device control method, and a program according to the present disclosure will be described in detail with reference to the accompanying drawings as appropriate. However, unnecessarily detailed descriptions may be omitted. For example, the detailed descriptions of well-known matters or the redundant descriptions of substantially the same configuration may be omitted. This is to avoid unnecessary redundancy of the following description and facilitate understanding of those skilled in the art. The accompanying drawings and the following description are provided for a person skilled in the art to fully understand the present disclosure, and are not intended to limit the subject matters described in the claims.

### Embodiment 1

### [Device Configuration]

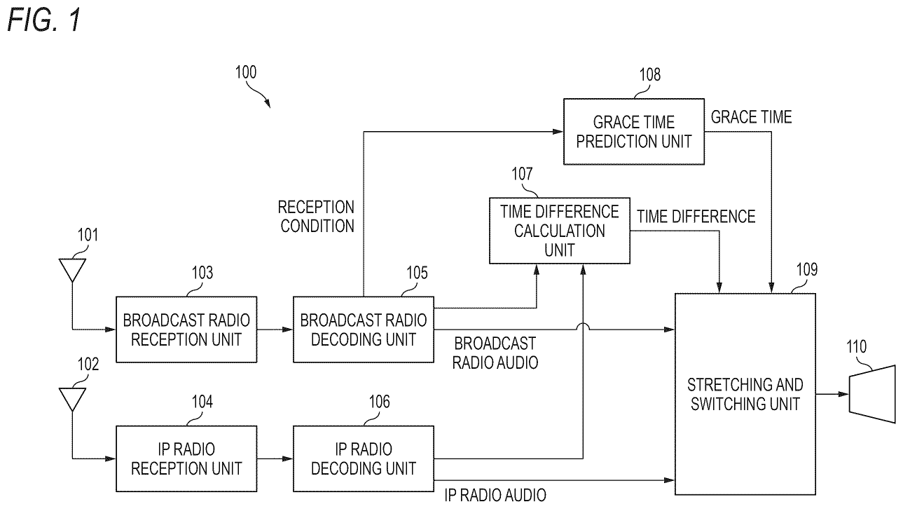

FIG. 1 is a block diagram illustrating a configuration example of a radio device according to Embodiment 1. In FIG. 1, arrows indicate an example of a flow of a signal to each block. A configuration and a signal flow illustrated in FIG. 1 are examples.

A radio device 100 according to the present embodiment is able to receive radio broadcasting and IP simulcast radio broadcasting (hereinafter also referred to as “IP radio broadcasting”) having the same service contents as the broadcasting. Each of the radio broadcasting and the IP radio broadcasting includes radio signals corresponding to a plurality of services, and a service selected from the plurality of services is output as an audio. In the present embodiment, it is assumed that radio broadcasting corresponding to the plurality of services and IP radio broadcasting corresponding to at least one service of the plurality of services can be received.

The radio device 100 according to the present embodiment is assumed to be, for example, an in-vehicle radio device that is mounted on a vehicle (not illustrated) and is operable by a user. The in-vehicle radio device may be configured as a single device that outputs a radio signal, or may be configured as one function of a navigation device. Further, the term “vehicle” is not limited to an ordinary passenger vehicle, and may be any movable body such as a two-wheeled vehicle, a bus, or a truck. Further, the configuration illustrated in FIG. 1 is an example, and one part may be divided into a plurality of parts, or a plurality of parts may be integrated into one. Here, only parts related to the functions according to the present embodiment are illustrated, and other functions may be further provided.

An antenna 101 receives a radio signal related to radio broadcasting and transmits the radio signal to a broadcast radio reception unit 103. The antenna 101 receives a radio signal of radio broadcasting in a predetermined frequency band transmitted from a neighboring base station. There is no particular limitation on the frequency band or standard. The antenna 102 receives a radio signal related to IP radio broadcasting and transmits the radio signal to an IP radio reception unit 104.

The broadcast radio reception unit 103 provides the received radio signal to a broadcast radio decoding unit 105. The IP radio reception unit 104 provides the received radio signal to an IP radio decoding unit 106.

The broadcast radio decoding unit 105 receives and decodes a radio signal of a frequency designated by a selection station of the user or the like from radio signals received by the broadcast radio reception unit 103. The radio signal of the designated frequency is received by, for example, filtering. The broadcast radio decoding unit 105 sets the decoded radio signal as a broadcast radio audio, and transmits the radio signal to a time difference calculation unit 107 and a stretching and switching unit 109. Further, the broadcast radio decoding unit 105 provides information on a reception condition of the received radio signal to a grace time prediction unit 108. The broadcast radio decoding unit 105 may further perform a noise identification or noise removal process.

The IP radio decoding unit 106 receives a radio signal of a frequency designated by a selection station of the user or the like from the radio signals received by the IP radio reception unit 104, and decodes the received radio signal. The IP radio decoding unit 106 sets the decoded radio signal as an IP radio audio, and transmits the radio signal to the time difference calculation unit 107 and the stretching and switching unit 109.

The time difference calculation unit 107 compares the received broadcast radio audio with the IP radio audio, and calculates a time difference therebetween. An example of a calculation method of the time difference will be described later. The time difference calculation unit 107 transmits information on the calculated time difference to the stretching and switching unit 109.

The grace time prediction unit 108 predicts the grace time until switching based on the received reception condition. An example of a prediction method of the grace time will be described later. The grace time prediction unit 108 transmits the predicted grace time to the stretching and switching unit 109.

The stretching and switching unit 109 controls stretching and switching of the radio audio to be output based on the received radio audio and time information, and outputs the radio audio to an audio output unit 110. The audio output unit 110 outputs the received radio audio using a speaker or the like.

Each block illustrated in FIG. 1 may be implemented by a control unit, a storage unit, or the like (not illustrated). The control unit (not illustrated) may be implemented by using, for example, a central processing unit (CPU), a micro processing unit (MPU), a digital signal processor (DSP), a graphical processing unit (GPU), or a field programmable gate array (FPGA). The storage unit (not illustrated) is a storage area for storing and retaining various data, and may be implemented by, for example, a non-volatile storage area such as a read only memory (ROM) or a hard disk drive (HDD), or a volatile storage area such as a random access memory (RAM). For example, the control unit may implement some or all of the functions of the blocks illustrated in FIG. 1 by reading and executing various data and programs stored in the storage unit.

### [Process Flow]

### (Switching Process)

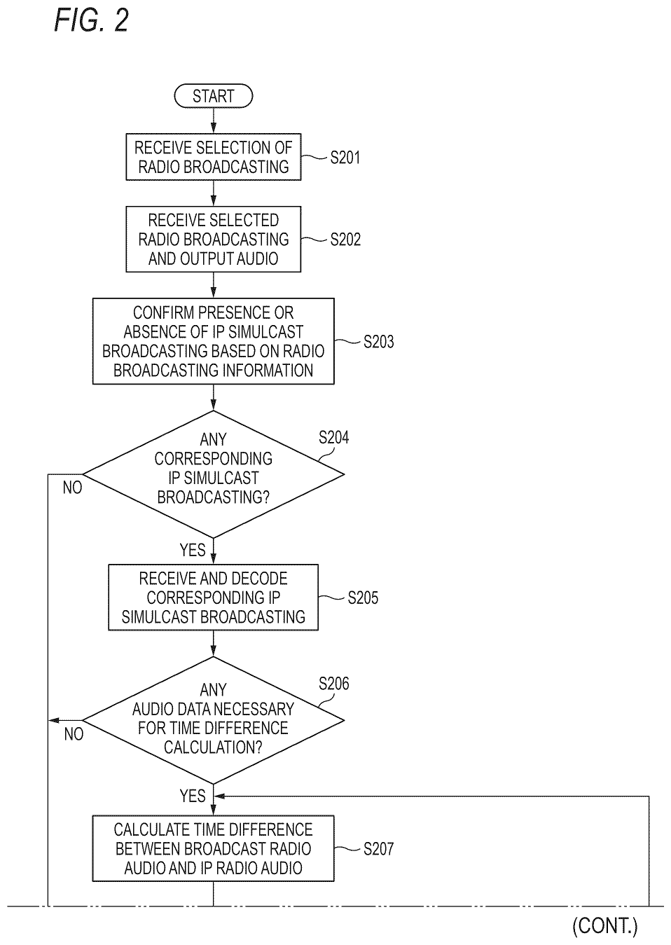

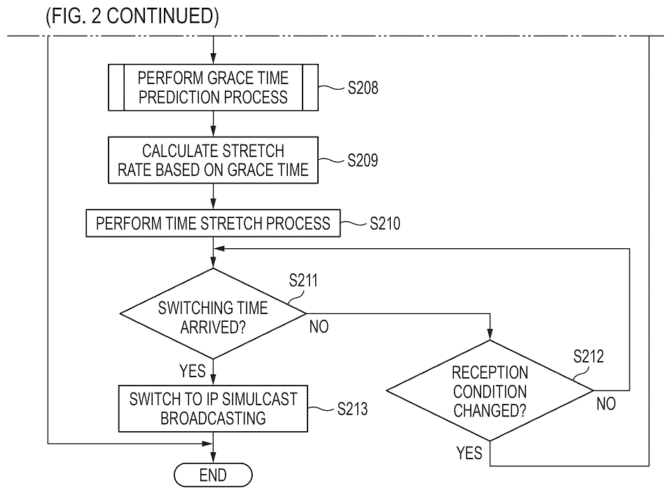

FIG. 2 is a flowchart of a switching process according to the present embodiment. This process flow is realized in cooperation with each block of the radio device 100 illustrated in FIG. 1. For ease of explanation, a processing entity will be collectively described as the radio device 100.

In this example, it is assumed that the radio broadcasting of the same service content and the IP radio broadcasting are receivable and the radio broadcasting is switched to the IP radio broadcasting. In general, when the radio broadcasting of the same service content is compared with the IP radio broadcasting (IP simulcast broadcasting), for example, for the reason that the IP radio broadcasting requires time for decoding, the IP radio broadcasting may be delayed when an audio is output. Here, the description will be made on the assumption that the IP radio audio is delayed.

The radio device 100 receives selection of a desired service from among a plurality of services that can be received by radio broadcasting (step S201). Here, the selection may be specified by the user using, for example, a user interface included in the radio device 100, or the radio device 100 may select any service according to the preference of the user.

The radio device 100 receives a radio signal of a service of the radio broadcasting selected in step S201 and outputs the radio signal as an audio (step S202).

The radio device 100 confirms the presence or absence of IP simulcast broadcasting corresponding to the service selected in step S201 (step S203). The presence or absence of the IP simulcast broadcasting can be determined based on, for example, information given to a radio signal of radio broadcasting.

As a result of the confirmation in step S203, the radio device 100 determines whether there is corresponding IP simulcast broadcasting (step S204). When there is corresponding IP simulcast broadcasting (step S204: YES), the process performed by the radio device 100 proceeds to step S205. On the other hand, when there is no corresponding IP simulcast broadcasting (step S204: NO), this process flow ends. In this case, an audio output of a service of the broadcasting received in step S201 is continued until a stop instruction of the radio device 100 is received, or the service is changed, or a reception condition of a broadcast signal is deteriorated to disable the audio output.

The radio device 100 receives and decodes a radio signal of the corresponding IP simulcast broadcasting (step S205).

The radio device 100 determines whether there is data necessary for time difference calculation based on audio data of the broadcasting received in step S202 and audio data of the IP simulcast broadcasting decoded in step S205 (step S206). As the data necessary for the time difference calculation, for example, reception accuracy information, a reception period, and the like of the IP simulcast broadcasting may be used, and the determination may be made based on the comparison between these data and threshold values. When there is audio data necessary for the time difference calculation (step S206: YES), the process performed by the radio device 100 proceeds to step S207. On the other hand, when there is no audio data necessary for the time difference calculation (step S206: NO), this process flow ends. In this case, the operations may be performed in the same manner as when there is no corresponding IP simulcast broadcasting.

The radio device 100 calculates a time difference, that is, a time difference between the broadcast radio audio and the output of the IP radio audio (step S207). The time difference is calculated based on the correlation between signals. Since the contents are the same, the characteristics of signal waveforms are substantially the same. Therefore, the time difference can be derived by correlating the broadcast radio audio with the IP radio audio. Here, a method of deriving signal correlation may be a known method, and is not particularly limited.

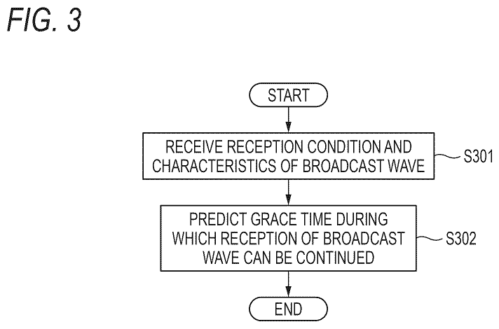

The radio device 100 performs a grace time prediction process (step S208). Details of the process of this step will be described later with reference to FIG. 3.

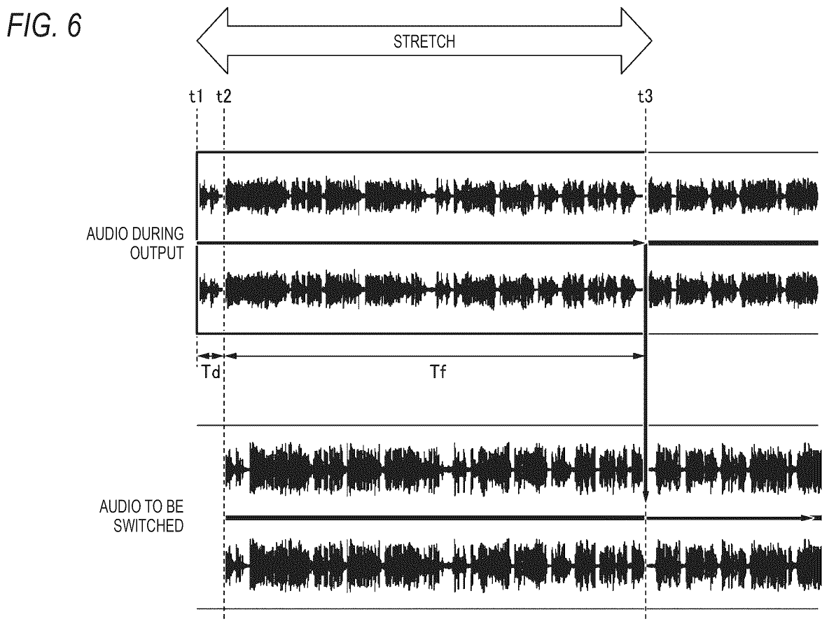

The radio device 100 calculates a stretch rate based on the grace time calculated in step S209 (step S209). An example of a stretch rate calculation method will be described later with reference to FIG. 6 and the like.

The radio device 100 performs a time stretch process on the broadcast radio audio based on the stretch rate calculated in step S209 (step S210). An example of the time stretch process will be described with reference to FIG. 6 and the like.

The radio device 100 determines whether the radio broadcasting has reached a switching timing based on the time difference calculated in step S207 (step S211). The switching timing will be described with reference to FIG. 6 and the like. When the switching timing has been reached (step S211: YES), the process performed by the radio device 100 proceeds to step S213. On the other hand, when the switching timing has not been reached (step S211: NO), the process performed by the radio device 100 proceeds to step S212.

The radio device 100 compares reception conditions of the radio broadcasting and the IP radio broadcasting with reception conditions of the radio broadcasting and the IP radio broadcasting at the time of calculating the grace time in step S208, and determines whether the reception condition has changed (step S212). Here, the determination may be made based on whether the reception condition of only one of the radio broadcastings is changed. In addition, whether the reception condition has deteriorated may be determined as a change. When the reception condition has changed (step S212: YES), the process performed by the radio device 100 returns to step S207 and repeats the process. On the other hand, when the reception condition has not changed (step S212: NO), the process performed by the radio device 100 returns to step S211 and repeats the process.

The radio device 100 switches an audio output from the radio broadcasting to the IP simulcast broadcasting received in step S205 (step S213). Then, this process flow ends. In this case, an audio output of a service of the received IP simulcast broadcasting is continued until a stop instruction of the radio device 100 is received, or the service is changed, or a reception condition of the IP simulcast broadcasting is deteriorated and the playback is disabled.

### (Grace Time Prediction Process)

FIG. 3 is a flowchart of a grace time prediction process according to the present embodiment. This process corresponds to the process of step S208 in FIG. 2.

The radio device 100 receives information on a reception state and characteristics of the broadcast wave (step S301). Specific examples of the information received here include history information of a reception level of the broadcasting of the selected service, that is, an amount of change.

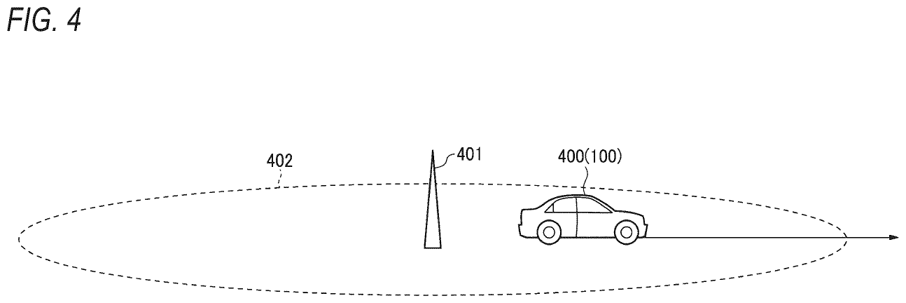

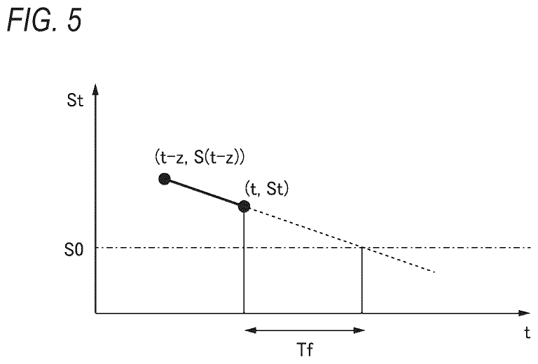

Based on the information received in step S301, the radio device 100 predicts a grace time during which reception of a broadcast wave can be continued (step S302). The prediction method of the grace time will be described later with reference to FIGS. 4 and 5. This process flow ends, and the process proceeds to the process of step S209 in FIG. 2.

### [Grace Time and Stretch Rate]

A grace time of switching from the radio broadcasting to the IP radio broadcasting according to the present embodiment will be described with reference to FIG. 4. As illustrated in FIG. 4, the radio device 100 according to the present embodiment is loaded on a movable body such as a vehicle 400 and is movable. In the radio broadcasting, a radio signal is transmitted from a base station 401 including a transmitting antenna, and an effective range 402 in which a radio signal can be received is defined. The effective range 402 may vary depending on various factors such as a height of the transmitting antenna, signal intensity, and terrain. Furthermore, even in the effective range 402, a reception level receivable by the radio device 100 may change due to the above-described factors. As the reception level is high, a radio audio can be output more stably.

Here, in order to simplify the description, only one vehicle 400 and one base station 401 are illustrated, but there are a plurality of vehicles 400 and base stations 401. Further, the effective ranges 402 of a plurality of radio broadcastings are also overlapped.

The vehicle 400 is movable inside and outside the effective range 402. In the example of FIG. 4, the vehicle 400 is moving toward outside of the effective range 402 of the broadcasting of a certain service. In this case, a time until the vehicle 400 goes out of the effective range 402 is defined as a grace time Tf.

FIG. 5 is a graph illustrating the prediction method of the grace time. A horizontal axis represents a time, and a vertical axis represents a reception level. A reception level S0 corresponds to a reception level at one end of the effective range 402 illustrated in FIG. 4. In a case of a reception level lower than the reception level S0, a radio audio cannot be output or the output quality cannot be guaranteed.

A reception level S(t) at a certain time point t of the radio device 100 and a reception level S(t-z) at a time point (t-z) before a period z from the time point t are indicated as two points. It is assumed that the information is appropriately received as history information. The period z is a predetermined time duration. An amount of change dSt of a reception level per unit time illustrated in FIG. 5 can be defined by the following formula (1).

$$\begin{matrix}[ Equation 1 ] & \\ dSt = \frac{\{ S ( t ) - S ( t - z ) \}}{z} & ( 1 )\end{matrix}$$

Based on the amount of change dSt, a time from the time point t which is a current time point to a time point at which the reception level reaches S0 is derived as the grace time Tf Here, the prediction method is merely an example. For example, the grace time may be derived based on three or more pieces of history information, or another prediction method may be used. Further, a formula other than the above formula (1) may be used. This process is performed in the process flow in FIG. 3.

In the examples of FIGS. 4 and 5, a case where the vehicle 400 on which the radio device 100 is mounted is moving toward outside of the effective range 402 is illustrated as an example. On the other hand, for example, when the vehicle 400 is moving closer to the base station 401 in the effective range 402, it is assumed that the reception level increases and the output quality of the broadcasting improves. In such a case, the grace time tends to increase. Therefore, when the grace time increases and exceeds a certain threshold value, a part of the process in FIG. 2 may be interrupted for a predetermined period.

Instead of the reception level, a bit error rate (BER) may be used, or a BER and a reception level may be combined.

Further, the stretch rate is derived based on the grace time. FIG. 6 is a conceptual diagram illustrating a stretch rate and a stretch process using the stretch rate according to the present embodiment. An upper graph in FIG. 6 illustrates an example of a signal waveform of the broadcasting that currently outputs an audio. A lower graph in FIG. 6 illustrates an example of a signal waveform of the IP radio broadcasting to be switched to.

As described above, the IP radio broadcasting tends to output an audio later than the broadcasting. The delay here is illustrated as a time difference Td. When switching from the broadcasting to the IP radio broadcasting, a signal of the broadcasting is stretched at the stretch rate R in a certain period before the switching in consideration of the time difference. The stretched period is the grace time Tf. In the present embodiment, the stretch rate R is defined by the following formula (2).

$$\begin{matrix}[ Equation 2 ] & \\ R = 1 + \frac{Td}{Tf} & ( 2 )\end{matrix}$$

In the example of FIG. 6, at the timing of a time t3, the broadcasting is switched to the IP radio broadcasting, and a radio signal of the previous broadcasting is stretched and synchronized at the stretch rate R. The stretch rate R is adjusted in accordance with a change in the time difference Td and the grace time Tf.

For example, in a case where the time difference is one minute (=60 seconds), when the predicted grace time is 40 minutes, the stretch rate may be set to 2.5%. In a case where the time difference is one minute (=60 seconds), when the predicted grace time is 20 minutes, the stretch rate may be set to 5%. In a case where the time difference is one minute (=60 seconds), when the predicted grace time is 10 minutes, the stretch rate may be set to 10%. In other words, when the stretch rate is 10% in a case where the time difference is 60 seconds, it takes 600 seconds until switching.

The stretch rate calculation method is not limited to the above. For example, when there is no possibility that the grace time Tf≤0, that is, the radio device 100 will come out of the effective range, the stretch rate R may be set to 1. That is, the stretch rate may be set so as not to stretch. Alternatively, a predetermined minimum stretch rate Rmin may be used.

A maximum stretch rate Rmax may be defined in advance for the stretch rate R. In a case where the calculated stretch rate R exceeds the maximum stretch rate Rmax, the process may be performed as follows. Here, the case where the maximum stretch rate Rmax is exceeded corresponds to, for example, a case where the time difference Td is long or a case where the grace time Tf is short, and the case where the time difference Td is long corresponds to a case where a time necessary for synchronizing a radio signal for the switching timing is long. The case where the grace time Tf is short corresponds to a case where a time until the radio device 100 goes out of the effective range is short.

For example, in the case of R>Rmax, the radio signal may be stretched at the maximum stretch rate Rmax. The maximum stretch rate Rmax is set within a range in which the user does not feel uncomfortable due to the stretch. The maximum stretch rate Rmax may be switched according to the service content of the radio broadcast.

A method other than the stretch may be combined to secure a time until the switching of the radio signal. For example, a time until the grace time elapses may be filled by inserting an output section in which a signal different from the radio signal is output. An example of the output section may be a silent section. In this case, an insertion position of the silent section may be adjusted according to the content of the service. For example, a silent section may be inserted between a tune and a tune. Alternatively, an announcement section having a predetermined time duration may be inserted instead of the silent section. Alternatively, audio information or the like preset by the user may be used. Accordingly, it is possible to complement the output until the switching timing without stretching the radio audio of the broadcasting.

In a case where the time difference Td is large, control may be performed so as not to perform stretching. The case where the time difference Td is large is, for example, a case where the time difference Td is 10% or more of the grace time Tf. At this time, when a degree of certainty of the derived time difference Td or the grace time Tf is low, the determination may be suspended until a certain degree of certainty is reached, and the control may be performed to stretch at the maximum stretch rate Rmax. The degree of certainty here corresponds to reliability for a derivation result, and for example, in a case where data for a predetermined time or more, that is, history information is derived in a state of not being obtained, the degree of certainty may be low.

When the time difference Td occurs, the time stretch process, that is, the stretch of the broadcast radio audio is not necessarily performed. For example, when the time difference Td is equal to or less than the predetermined threshold value, the time stretch process may be omitted on the assumption that an influence of discomfort of the user at the time of switching is small.

### (Modification 1)

In the above process, one broadcasting and one IP radio broadcasting corresponding thereto are assumed to be switched in a certain service. On the other hand, depending on the area, the same service content may be provided in a plurality of different channels in broadcasting.

In consideration of the above case, as a modification of the present embodiment, a configuration will be described in which a grace time is predicted based on a plurality of broadcastings that provide the same service, and then the broadcasting is switched to the IP radio broadcasting. A system configuration example illustrated in FIG. 1 and a flow of a switching process illustrated in FIG. 2 are the same.

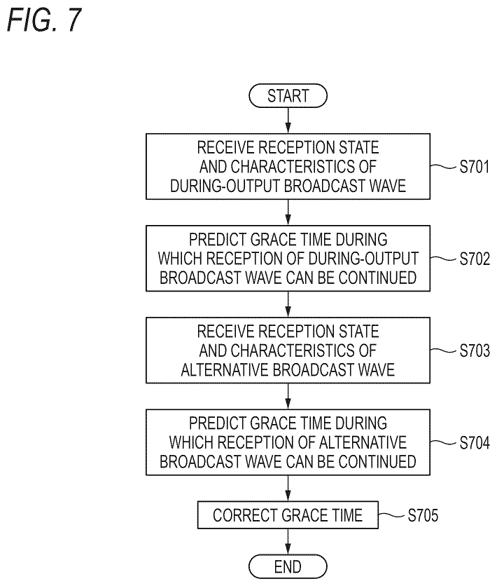

FIG. 7 is a flowchart of a grace time calculation process according to the present modification. The process flow illustrated in FIG. 7 is performed instead of the process flow in FIG. 3 described above. Here, for convenience, among a plurality of broadcastings having the same service content, the broadcasting that currently outputs an audio is referred to as a “during-output broadcast wave”. Among the plurality of broadcastings, a switchable broadcasting is referred to as an “alternative broadcast wave”.

The radio device 100 receives information on a reception state and characteristics of the during-output broadcast wave (step S701). The information received here may be the same as that in step S301 in FIG. 3.

Based on the information received in step S701, the radio device 100 predicts a grace time during which reception of a during-output broadcast wave can be continued (step S702). The prediction method here may be the same as that in step S302 in FIG. 3. For convenience, the grace time Tf predicted in this step is also referred to as a “first grace time”.

The radio device 100 receives information on a reception state and characteristics of the alternative broadcast wave (step S703). The information received here may be the same as that in step S701.

Based on the information received in step S703, the radio device 100 predicts a grace time during which reception of the alternative broadcast wave can be continued (step S704). The prediction method here may be the same as that in step S702. For convenience, a grace time Tf′ predicted in this step is also referred to as a “second grace time”.

The radio device 100 corrects the grace time predicted in step S702 with the grace time predicted in step S704 (step S705). For example, the grace times Tf and Tf′ may be compared, and the longer one may be set as the grace time. Alternatively, the grace times Tf and Tf may be compared, and if Tf is longer, correction may be performed by multiplying Tf by a predetermined coefficient. The predetermined coefficient may be a fixed value or may be derived based on a difference between the grace times Tf and Tf′.

Although a case where the number of alternative broadcasting is one has been described as an example, more alternative broadcast waves may be assumed. In such a case, one having the longest grace time may be used. Alternatively, the predetermined coefficient may be adjusted in accordance with the number of alternative broadcast waves. This process flow ends, and the process proceeds to the process of step S209 in FIG. 2.

When the audio quality and the reception level of the broadcasting that currently outputs an audio are lowered, the radio device 100 may perform control to switch to the alternative broadcast wave with higher quality before switching to the IP radio broadcasting.

As described above, the radio device (for example, 100) according to the present embodiment includes: a first reception unit (for example, 101, 103, and 105) that receives a radio signal of radio broadcasting; a second reception unit (for example, 102, 104, and 105) that receives a radio signal of IP simulcast radio broadcasting; a time difference calculation unit (for example, 107) that calculates a time difference between a broadcast radio audio based on the radio signal received by the first reception unit and an IP radio audio based on the radio signal received by the second reception unit; a prediction unit (for example, 108) that predicts a grace time until switching from the broadcast radio audio to the IP radio audio based on the time difference; a stretch rate calculation unit (for example, 109) that calculates a stretch rate based on the grace time; and a switching unit (for example, 109 and 110) that stretches the broadcast radio audio using the stretch rate to output an audio until the grace time elapses, and switches to an audio output of the IP radio audio when the grace time elapses. According to this configuration, it is possible to reduce discomfort of the user at the time of switching a broadcast in a radio device mounted on a vehicle or the like. In particular, it is possible to achieve both the minimization of the stretch rate for the output of the audio before the switching and the minimization of a time required for matching the switching timing.

In addition, in the radio device, the prediction unit may predict a grace time based on an amount of change per unit time of the reception level of the radio signal of the radio broadcasting and the predetermined reception level. According to this configuration, it is possible to predict the grace time from the radio broadcasting to the IP radio broadcasting more easily.

In addition, in the radio device, the radio broadcasting may include a plurality of radio signals having the same content, the time difference calculation unit may calculate a time difference of the IP radio audio for each broadcast radio audio based on the plurality of radio signals, and the prediction unit may predict the grace time based on the time difference of the IP radio audio for each broadcast radio audio based on the plurality of radio signals. According to this configuration, it is possible to calculate a grace time until switching to the IP radio broadcasting in consideration of a plurality of radio broadcastings having the same content.

In addition, in the radio device, the stretch rate calculation unit sets the stretch rate to 1 or a minimum stretch rate defined in advance when the grace time exceeds a predetermined threshold value. According to this configuration, when the possibility of switching from the radio broadcasting to the IP radio broadcasting is low, the output of the radio audio of the radio broadcasting can be controlled to be close to an original signal.

In addition, in the radio device, the stretch rate calculation unit sets the stretch rate to the maximum stretch rate when the stretch rate calculated based on the grace time exceeds a maximum stretch rate defined in advance. According to this configuration, by controlling the output of the radio broadcasting using an upper limit of the stretch rate, it is possible to reduce discomfort of the user due to the stretch.

In the radio device, when the stretch rate calculated based on the grace time exceeds a maximum stretch rate defined in advance, the switching unit inserts a predetermined output section into the broadcast radio audio before the grace time elapses and outputs the broadcast radio audio, instead of stretching based on the stretch rate. According to this configuration, by inserting any output instead of stretching, it is possible to reduce discomfort of the user due to the stretch.

In the radio device, the predetermined output section is a silent section or an announcement section including a predetermined audio message. According to this configuration, it is possible to adjust a switching timing using information with no discomfort when the radio broadcasting is output.

### Embodiment 2

Embodiment 2 according to the present disclosure will be described. In Embodiment 2, it is assumed that a radio device can receive information from a vehicle or the like, and the information is used.

### (System Configuration)

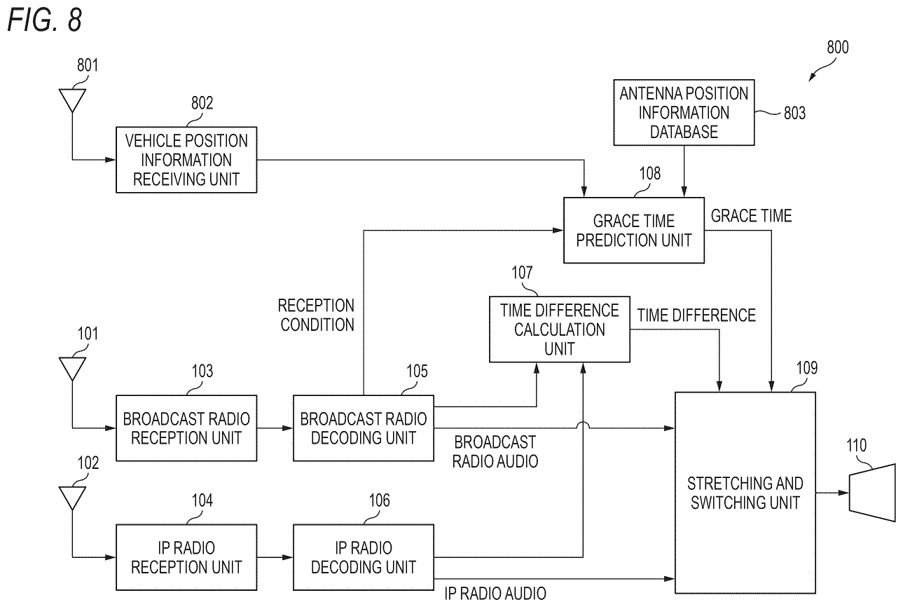

FIG. 8 is a block diagram illustrating a configuration example of a radio device 800 according to Embodiment 2. The same components as those in FIG. 1 described in Embodiment 1 are denoted by the same reference numerals, and detailed descriptions thereof are omitted. As differences from the configuration example of FIG. 1 illustrated in Embodiment 1, the radio device 800 further includes a communication unit 801, a vehicle position information receiving unit 802, and an antenna position information database 803.

The communication unit 801 is a communication interface for communicating with an external system (not illustrated). Here, as the communication unit 801, a position sensor for receiving position information of the vehicle 400 on which the radio device 800 is mounted is assumed. The position sensor may be, for example, a position sensor using a global navigation satellite system (GNSS) represented by a global positioning system (GPS). The vehicle position information receiving unit 802 receives position information of the radio device 800 via the communication unit 801. The received position information is provided to the grace time prediction unit 108.

The antenna position information database 803 is a database in which information on a base station is stored. The antenna position information database 803 may include, for example, a position (latitude and longitude) of a transmitting antenna of a base station, transmission power of the transmitting antenna, antenna gain of the transmitting antenna, and an antenna height of the transmitting antenna. The contents of the antenna position information database 803 may be appropriately updated by a processing unit (not illustrated). In addition, the antenna position information database 803 may be provided outside the radio device 800, and the information may be received via the communication unit 801 or the like as necessary. Various pieces of information received by referring to the antenna position information database 803 are provided to the grace time prediction unit 108.

The grace time prediction unit 108 according to the present embodiment predicts a grace time using the position information of the vehicle 400 and antenna position information in addition to a reception condition of a radio signal from the broadcast radio decoding unit 105.

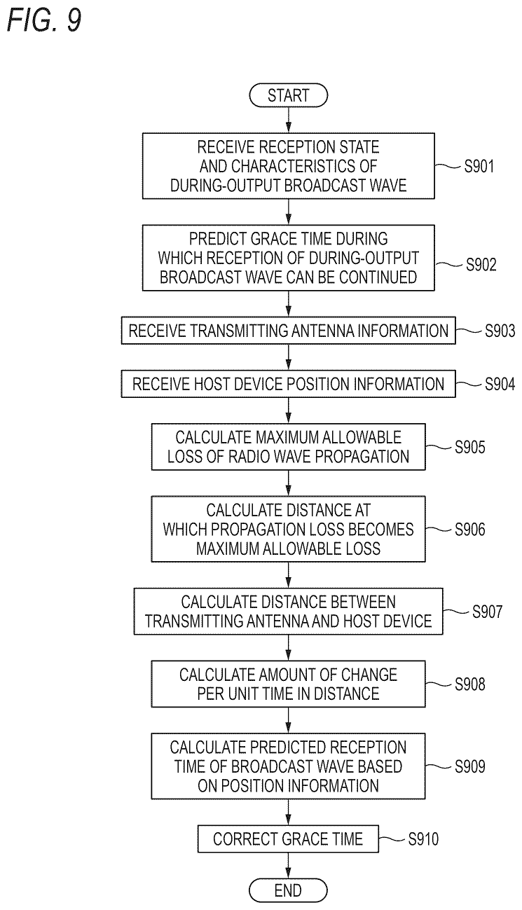

FIG. 9 is a flowchart of a grace time calculation process according to the present embodiment. The grace time calculation process is performed instead of FIG. 3 described above in Embodiment 1.

The radio device 800 receives information on the reception state and the characteristics of the broadcast wave during an audio output (step S901). The information received here may be the same as that in step S301 in FIG. 3.

Based on the information received in step S901, the radio device 800 predicts a grace time during which reception of a broadcast wave during an audio output can be continued (step S902). The prediction method here may be the same as that in step S302 in FIG. 3. The predicted grace time is defined as a grace time Tfbr.

The radio device 800 refers to the antenna position information database 803 to receive transmitting antenna information during an audio output (step S903). Further, the radio device 800 receives information on an antenna of the host device. Examples of the information on the antenna of the host device include antenna reception power, antenna gain, reception limit power, and an antenna height. The information on the antenna of the host device may be stored in a storage unit (not illustrated) of the radio device 800 in advance.

The radio device 800 receives position information on the host device via the vehicle position information receiving unit 802 (step S904).

The radio device 800 calculates a maximum allowable loss of radio wave propagation of the radio signal using the transmitting antenna information received in step S903 and the information on the antenna of the host device received in step S904 (step S905). A propagation loss Los of the radio wave can be defined by the following relational expression (3).

$$\begin{matrix}[ Equation 3 ] & \\ Pr = Pt + Gt - Los + Gr & ( 3 )\end{matrix}$$

Here, Pr is a reception power [dBm] of an antenna of a host device; Pt is a transmission power [dBm] of a transmitting antenna; Gt is an antenna gain [dB] of the transmitting antenna; Los is a propagation loss [dB]; and Gr is an antenna gain [dB] of the host device.

Further, when the propagation loss Los (that is, maximum allowable loss) at the time when the reception power Pr becomes a reception level S0 which is the reception limit power is denoted by Losw, the following relational expression (4) can be defined.

$$\begin{matrix}[ Equation 4 ] & \\ Losw = Pt + Gt + Gr - S 0 & ( 4 )\end{matrix}$$

Here, S0 is a reception limit power [dBm].

The radio device 800 derives a distance Rw at which the propagation loss of the radio wave becomes the maximum allowable loss Losw calculated in step S905 (step S906). The distance Rw at which the maximum allowable loss Losw is obtained can be derived from a propagation loss equation or data. For example, it is possible to use a known method such as a plane ground propagation loss (two-wave model), a spherical diffraction propagation loss, an Okumura-Hata model, or Recommendation ITU-RP. 1546-6.

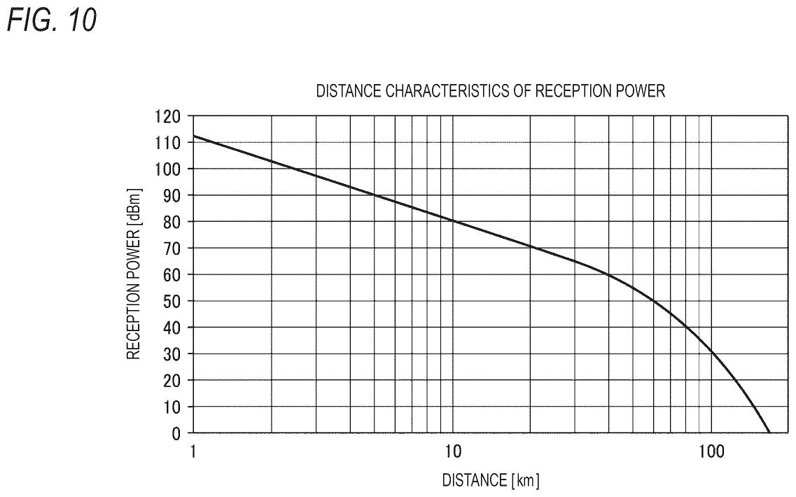

FIG. 10 is a graph illustrating the relation between the reception power and a distance. A vertical axis represents reception power [dB], and a horizontal axis represents a distance [km]. FIG. 10 illustrates an example of a result obtained by calculating the reception power using a known Okumura-Hata model and a spherical diffraction propagation loss equation. Since this calculation method is well known, detailed descriptions are omitted. A distance between the transmitting antenna and the radio device at which the propagation loss of the radio wave becomes the maximum allowable loss Losw can be derived based on the relation as illustrated in FIG. 10.

The radio device 800 calculates the distance between the transmitting antenna and the host device using the transmitting antenna information received in step S903 and the position information of the host device received in step S904 (step S907).

The radio device 800 calculates an amount of change per unit time in the distance calculated in step S907 (step S908). The calculated distance may be stored as history information as appropriate, and the amount of change may be calculated based on the history information.

The radio device 800 calculates a predicted reception time of a broadcast wave during reception based on the amount of change calculated in step S908 (step S909). The predicted reception time corresponds to a grace time from a range in which a radio signal of the broadcasting from the transmitting antenna can be received. Here, the grace time is calculated based on the information on the transmitting antenna and the information on the radio device 100. The predicted reception time Tfx here can be calculated by the following formula (5), for example.

$$\begin{matrix}[ Equation 5 ] & \\ Tfx = \frac{( Rw - Lt )}{dLt} & ( 5 )\end{matrix}$$

Here, Tfx is a predicted reception time [s]; Rw is a distance [m] at which the propagation loss becomes the maximum allowable loss Losw; Lt is a distance [m] between the transmitting antenna and the antenna device; and DLt is an amount of change in distance [m/s].

The radio device 100 corrects the grace time Tfbr predicted in step S902 with the predicted reception time Tfx predicted in step S909 (step S910). For example, the grace time is calculated by weighting the grace time Tfbr and the predicted reception time Tfx by the following formula (6).

$$\begin{matrix}[ Equation 6 ] & \\ Tf = Wt \times Tfbr \times ( 1 - Wt ) \times Tfx & ( 6 )\end{matrix}$$

Here, Wt is a weight coefficient (0≤Wt≤1).

The correction method is not limited to the above, and other methods may be used. For example, the reliability of each of the grace time Tfbr and the predicted reception time Tfx may be calculated, and the one having higher reliability may be used as the grace time. The reliability in this case may be determined based on, for example, a deviation from an average value of the past predicted times. This process flow ends, and the process proceeds to the process of step S209 in FIG. 2.

As described above, the radio device (for example, 800) according to the present embodiment further includes a receiving unit (for example, 801, 802, and 803) that receives information on a transmitting antenna that transmits the radio signal of the radio broadcasting and position information on the radio device. The prediction unit is further configured to derive a distance as an allowable propagation loss of the radio signal from the transmitting antenna and an amount of change in a distance per unit time between the transmitting antenna and the radio device based on the information on the transmitting antenna and the position information, calculate a predicted reception time until the radio signal from the transmitting antenna is out of a receivable range by using the distance as the allowable propagation loss and the amount of change in the distance per unit time, and correct the grace time predicted based on the time difference by using the predicted reception time. According to this configuration, it is possible to further improve the accuracy of the grace time using the information on the transmitting antenna and the host device as the prediction result. Therefore, it is possible to specify a more appropriate timing for switching from the radio broadcasting to the IP radio broadcasting.

In addition, in the radio device, the prediction unit may perform correction by weighted addition of the grace time predicted based on the time difference and the predicted reception time. According to this configuration, it is possible to correct the grace time using a simple method.

In addition, in the radio device, the prediction unit may perform the correction based on reliability of each of the grace time predicted based on the time difference and the predicted reception time. According to this configuration, it is possible to further improve the accuracy of the grace time using the reliability according to each prediction result.

### Other Embodiments

In the above embodiment, although an example of switching between broadcasting and IP radio broadcasting has been described, the present disclosure is not limited to this combination. A configuration of the present disclosure can be applied to any combination as long as a delay may occur when each radio broadcast is switched.

In the example of FIG. 5, a value of the reception level S0 is used as a threshold value for reception, but the present disclosure is not limited thereto. For example, the reception level S0 may be corrected. For example, in an environment where there is alternative broadcasting, a radio signal may be disturbed by multipath or adjacent channels. In consideration of such an influence, correction may be performed such that the reception level S0 is multiplied by a predetermined coefficient to be larger than 1. The predetermined coefficient may be changed in accordance with a moving speed of the radio device. For example, when a vehicle equipped with a radio device is traveling at a certain speed or higher, the predetermined coefficient may be controlled to be high. Further, the predetermined coefficient may be increased or decreased in accordance with the interference resistance of a signal indicated by information on a codec of a broadcast wave.

It is also possible to implement a process in which programs and applications for implementing the functions of the one or more embodiments described above are supplied to a system or device using a network, storage medium, or the like, and are read and executed by one or more processors in a computer of the system or device.

The process may be implemented by a circuit (for example, application specific integrated circuit (ASIC) or field programmable gate array (FPGA)) that implements one or more functions.

In the present specification, expressions “first” and “second” are used to distinguish from other elements in the description, and are not intended to be interpreted as being limited to specific components. Therefore, according to the present disclosure, it is understood that the present disclosure may be appropriately replaced with other configurations or the like to which the present disclosure is applied.

Although various embodiments have been described above with reference to the drawings, it is needless to say that the present disclosure is not limited to such examples. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, the components in the various embodiments described above may be combined freely in a range without deviating from the spirit of the disclosure.

### APPENDIX

The following techniques are disclosed based on the above description of the embodiments.

### (Technique 1)

A radio device includes: a first reception unit configured to receive a radio signal of radio broadcasting; a second reception unit configured to receive a radio signal of IP simulcast radio broadcasting; a time difference calculation unit configured to calculate a time difference between a broadcast radio audio based on the radio signal received by the first reception unit and an IP radio audio based on the radio signal received by the second reception unit; a prediction unit configured to predict a grace time until switching from the broadcast radio audio to the IP radio audio based on the time difference; a stretch rate calculation unit configured to calculate a stretch rate based on the grace time; and a switching unit configured to stretch the broadcast radio audio using the stretch rate to output an audio until the grace time elapses, and switch to an audio output of the IP radio audio when the grace time elapses. According to this configuration, it is possible to reduce discomfort of the user at the time of switching a broadcast in a radio device mounted on a vehicle or the like. In particular, it is possible to achieve both the minimization of the stretch rate for the output of the audio before the switching and the minimization of a time required for matching the switching timing.

### (Technique 2)

In the radio device according to the technique 1, the prediction unit predicts the grace time based on an amount of change per unit time of a reception level of the radio signal of the radio broadcasting and a predetermined reception level.

According to this configuration, it is possible to predict the grace time from the radio broadcasting to the IP radio broadcasting more easily.

### (Technique 3)

In the radio device according to the technique 1 or 2, the radio broadcasting includes a plurality of radio signals having the same content. The time difference calculation unit calculates a time difference of the IP radio audio for each broadcast radio audio based on the plurality of radio signals. The prediction unit predicts the grace time based on the time difference of the IP radio audio for each broadcast radio audio based on the plurality of radio signals.

According to this configuration, it is possible to calculate a grace time until switching to the IP radio broadcasting in consideration of a plurality of radio broadcastings having the same content.

### (Technique 4)

In the radio device according to any one of the techniques 1 to 3, the stretch rate calculation unit sets the stretch rate to 1 or a minimum stretch rate defined in advance when the grace time exceeds a predetermined threshold value.

According to this configuration, when the possibility of switching from the radio broadcasting to the IP radio broadcasting is low, the output of the radio audio of the radio broadcasting can be controlled to be close to an original signal.

### (Technique 5)

In the radio device according to any one of the techniques 1 to 3, the stretch rate calculation unit sets the stretch rate to a maximum stretch rate when the stretch rate calculated based on the grace time exceeds the maximum stretch rate defined in advance.

According to this configuration, by controlling the output of the radio broadcasting using an upper limit of the stretch rate, it is possible to reduce discomfort of the user due to the stretch.

### (Technique 6)

In the radio device according to any one of the techniques 1 to 3, when the stretch rate calculated based on the grace time exceeds a maximum stretch rate defined in advance, the switching unit inserts a predetermined output section into the broadcast radio audio before the grace time elapses and outputs the broadcast radio audio, instead of stretching by the stretch rate.

According to this configuration, by controlling the output of the radio broadcasting using an upper limit of the stretch rate, it is possible to reduce discomfort of the user due to the stretch.

### (Technique 7)

In the radio device according to the technique 6, the predetermined output section is a silent section or an announcement section including a predetermined audio message.

According to this configuration, it is possible to adjust a switching timing using information with no discomfort when the radio broadcasting is output.

### (Technique 8)

In the radio device according to the technique 1 or 2, the radio device further includes: a receiving unit configured to receive information on a transmitting antenna that transmits the radio signal of the radio broadcasting and position information on the radio device. The prediction unit is further configured to: derive a distance as an allowable propagation loss of the radio signal from the transmitting antenna and an amount of change in a distance per unit time between the transmitting antenna and the radio device based on the information on the transmitting antenna and the position information; calculate a predicted reception time until the radio signal from the transmitting antenna is out of a receivable range by using the distance as the allowable propagation loss and the amount of change in the distance per unit time; and correct the grace time predicted based on the time difference by using the predicted reception time.

According to this configuration, it is possible to further improve the accuracy of the grace time using the information on the transmitting antenna and the host device as the prediction result. Therefore, it is possible to specify a more appropriate timing for switching from the radio broadcasting to the IP radio broadcasting.

### (Technique 9)

In the radio device according to the technique 8, the prediction unit corrects the grace time by weighted addition of the grace time predicted based on the time difference and the predicted reception time.

According to this configuration, it is possible to correct the grace time using a simple method.

### (Technique 10)

In the radio device according to the technique 8, the prediction unit corrects the grace time based on reliability of each of the grace time predicted based on the time difference and the predicted reception time.

According to this configuration, it is possible to further improve the accuracy of the grace time using the reliability in accordance with each prediction result.

### (Technique 11)

A radio device control method includes: a first reception operation of receiving a radio signal of radio broadcasting; a second reception operation of receiving a radio signal of IP simulcast radio broadcasting; a calculation operation of calculating a time difference between a broadcast radio audio based on the radio signal received by the first reception operation and an IP radio audio based on the radio signal received by the second reception operation; a prediction operation of predicting a grace time until switching from the broadcast radio audio to the IP radio audio based on the time difference; a calculation operation of calculating a stretch rate based on the grace time; and a switching operation of stretching the broadcast radio audio using the stretch rate to output an audio until the grace time elapses, and switching to an audio output of the IP radio audio when the grace time elapses.

According to this configuration, it is possible to reduce discomfort of the user at the time of switching a broadcast in a radio device mounted on a vehicle or the like. In particular, it is possible to achieve both the minimization of the stretch rate for the output of the audio before the switching and the minimization of a time required for matching the switching timing.

### (Technique 12)

There are provided a program for causing a computer to execute a control process, and a non-transitory computer readable medium storing the program. The control process includes: a first reception operation of receiving a radio signal of radio broadcasting; a second reception operation of receiving a radio signal of IP simulcast radio broadcasting; a calculation operation of calculating a time difference between a broadcast radio audio based on the radio signal received by the first reception operation and an IP radio audio based on the radio signal received by the second reception operation; a prediction operation of predicting a grace time until switching from the broadcast radio audio to the IP radio audio based on the time difference; a calculation operation of calculating a stretch rate based on the grace time; and a switching unit of stretching the broadcast radio audio using the stretch rate to output an audio until the grace time elapses, and switching to an audio output of the IP radio audio when the grace time elapses.

According to this configuration, it is possible to reduce discomfort of the user at the time of switching a broadcast in a radio device mounted on a vehicle or the like. In particular, it is possible to achieve both the minimization of the stretch rate for the output of the audio before the switching and the minimization of a time required for matching the switching timing.

What is claimed is:

1. A radio device comprising:
a memory in which a program is stored; and
a processor coupled to the memory and configured to perform processing by executing the program, the processing including:
receiving a first radio signal which is a radio signal of radio broadcasting;
receiving a second radio signal which is a radio signal of IP simulcast radio broadcasting;
calculating a time difference between a broadcast radio audio based on the first radio signal and an IP radio audio based on the second radio signal;
predicting a grace time until switching from the broadcast radio audio to the IP radio audio based on the time difference;
calculating a stretch rate based on the grace time; and
stretching the broadcast radio audio using the stretch rate to output an audio until the grace time elapses, and switching to an audio output of the IP radio audio when the grace time elapses.

2. The radio device according to claim 1, wherein
the predicting of the grace time includes predicting the grace time based on an amount of change per unit time of a reception level of the first radio signal and a predetermined reception level.

3. The radio device according to claim 1, wherein
the radio broadcasting includes a plurality of radio signals having the same content,
the calculating of the time difference includes calculating a time difference of the IP radio audio for each broadcast radio audio based on the plurality of radio signals, and
the predicting of the grace time includes predicting the grace time based on the time difference of the IP radio audio for each broadcast radio audio based on the plurality of radio signals.

4. The radio device according to claim 1, wherein
the calculating of the stretch rate includes setting the stretch rate to 1 or a minimum stretch rate defined in advance when the grace time exceeds a predetermined threshold value.

5. The radio device according to claim 1, wherein
the calculating of the stretch rate includes setting the stretch rate to a maximum stretch rate when the stretch rate calculated based on the grace time exceeds the maximum stretch rate defined in advance.

6. The radio device according to claim 1, wherein
when the stretch rate calculated based on the grace time exceeds a maximum stretch rate defined in advance, the stretch includes inserting a predetermined output section into the broadcast radio audio before the grace time elapses and outputting the broadcast radio audio, instead of stretching by the stretch rate.

7. The radio device according to claim 6, wherein
the predetermined output section is a silent section or an announcement section including a predetermined audio message.

8. The radio device according to claim 1, wherein
the processing further includes:
receiving information on a transmitting antenna that transmits the radio signal of the radio broadcasting and position information on the radio device, wherein
the predicting of the grace time further includes:
deriving a distance as an allowable propagation loss of the radio signal from the transmitting antenna and an amount of change in a distance per unit time between the transmitting antenna and the radio device based on the information on the transmitting antenna and the position information;
calculating a predicted reception time until the radio signal from the transmitting antenna is out of a receivable range by using the distance as the allowable propagation loss and the amount of change in the distance per unit time; and
correcting the grace time predicted based on the time difference by using the predicted reception time.

9. The radio device according to claim 8, wherein
the predicting of the grace time includes correcting the grace time by weighted addition of the grace time predicted based on the time difference and the predicted reception time.

10. The radio device according to claim 8, wherein
the predicting of the grace time includes correcting the grace time based on reliability of each of the grace time predicted based on the time difference and the predicted reception time.

11. A radio device control method comprising:
receiving a radio signal of radio broadcasting;
receiving a radio signal of IP simulcast radio broadcasting;
calculating a time difference between a broadcast radio audio based on the radio signal and an IP radio audio based on the radio signal;
predicting a grace time until switching from the broadcast radio audio to the IP radio audio based on the time difference;
calculating a stretch rate based on the grace time; and
stretching the broadcast radio audio using the stretch rate to output an audio until the grace time elapses, and switching to an audio output of the IP radio audio when the grace time elapses.

12. A non-transitory computer readable medium storing a program for causing a computer to execute a control process, the control process comprising:
receiving a radio signal of radio broadcasting;
receiving a radio signal of IP simulcast radio broadcasting;
calculating a time difference between a broadcast radio audio based on the radio signal and an IP radio audio based on the radio signal;
predicting a grace time until switching from the broadcast radio audio to the IP radio audio based on the time difference;
calculating a stretch rate based on the grace time; and
stretching the broadcast radio audio using the stretch rate to output an audio until the grace time elapses, and switching to an audio output of the IP radio audio when the grace time elapses.
